(19) United States
(12) Patent Application Publication
(10) Pub. No.: US 2009/0014917 A1
(43) Pub. Date: Jan. 15, 2009

(54) Drop Pattern Generation for Imprint Lithography

(75) Inventors: Jared L. Hodge, Austin, TX (US); Philip D. Schumaker, Austin, TX (US)

Correspondence Address: MOLECULAR IMPRINTS, PO BOX 81536, AUSTIN, TX, 78708-1536, US

(73) Assignee: Molecular Imprints, Inc., Austin, TX (US)

(21) Appl. No.: 12/170,229

(22) Filed: Jul. 9, 2008

Related U.S. Application Data
(60) Provisional application No. 60/948,786, filed on Jul. 10, 2007.

(51) Int. Cl. B29C 35/04

(52) U.S. Cl. 264/401

(57) ABSTRACT

Generating a fluid drop pattern for an imprint lithography process includes selecting an imprinting surface and generating a fluid drop pattern including drop locations for placement of a multiplicity of drops of substantially equal volume on an imprint lithography substrate. The fluid drop pattern is generated through one or more modified Lloyd's method iterations. The fluid drop pattern allows substantially complete filling of imprinting surface features and formation of a substantially uniform residual layer during the imprint lithography process.

### CROSS-REFERENCE TO RELATED APPLICATIONS

This application claims the benefit under 35 U.S.C. §119(e)(1) of U.S. provisional application 60/948,786, filed Jul. 10, 2007, which is incorporated by reference herein in its entirety.

### STATEMENT REGARDING FEDERALLY SPONSORED RESEARCH OR DEVELOPMENT

The United States government has a paid-up license in this invention and the right in limited circumstances to require the patent owner to license others on reasonable terms as provided by the terms of SPAWAR N66001-06-C-2003 Nanoimprint Lithography Manufacturing Scale (NIMS) Award.

### TECHNICAL FIELD

The field of the invention relates generally to nano-fabrication of structures, and more particularly to generating a fluid drop pattern for imprint lithography.

### BACKGROUND

Nano-fabrication involves the fabrication of very small structures, e.g., having features on the order of nanometers or smaller. One area in which nano-fabrication has had a sizeable impact is in the processing of integrated circuits. As the semiconductor processing industry continues to strive for larger production yields while increasing the circuits per unit area formed on a substrate, nano-fabrication becomes increasingly important. Nano-fabrication provides greater process control while allowing increased reduction of the minimum feature dimension of the structures formed. Other areas of development in which nano-fabrication has been employed include biotechnology, optical technology, mechanical systems and the like.

An exemplary nano-fabrication technique is referred to as imprint lithography. Exemplary imprint lithography processes are described in detail in numerous publications, such as U.S. Pat. No. 6,980,259, entitled, “Method and a Mold to Arrange Features on a Substrate to Replicate Features having Minimal Dimensional Variability;” U.S. Patent Application Publication No. 2004/0065252 filed as U.S. patent application Ser. No. 10/264,926, entitled “Method of Forming a Layer on a Substrate to Facilitate Fabrication of Metrology Standards;” and U.S. Pat. No. 6,936,194, entitled “Functional Patterning Material for Imprint Lithography Processes,” all of which are assigned to the assignee of the present invention and incorporated by reference herein.

An imprint lithography technique disclosed in each of the aforementioned United States patent application publication and United States patents includes formation of a relief pattern in a polymerizable layer and transferring a pattern corresponding to the relief pattern into an underlying substrate. The substrate may be positioned upon a motion stage to obtain a desired position to facilitate patterning thereof. To that end, a template is employed spaced-apart from the substrate with a formable liquid present between the template and the substrate. The liquid is solidified to form a solidified layer that has a pattern recorded therein that is conforming to a shape of the surface of the template in contact with the liquid. The template is then separated from the solidified layer such that the template and the substrate are spaced-apart. The substrate and the solidified layer are then subjected to processes to transfer, into the substrate, a relief image that corresponds to the pattern in the solidified layer.

### SUMMARY

In one aspect, generating a fluid drop pattern for an imprint lithography process includes selecting an imprinting surface and generating a fluid drop pattern including drop locations for placement of a multiplicity of drops of substantially equal volume on an imprint lithography substrate. The fluid drop pattern is generated through one or more modified Lloyd's method iterations. The fluid drop pattern allows substantially complete filling of imprinting surface features and formation of a substantially uniform residual layer during the imprint lithography process.

In another aspect, forming a patterned layer on a substrate in imprint lithography includes selecting an imprinting surface, and generating a fluid map to represent a distribution of fluid volume effective to allow successful replication of the imprinting surface. A modified Lloyd's method is used to generate a fluid drop pattern from the fluid map. The fluid drop pattern includes drop locations for drops of substantially equal volume. Fluid is applied to the substrate according the fluid drop pattern, and the fluid is solidified on the substrate to form a patterned layer on the substrate. The patterned layer is a successful replication of the imprinting surface.

### BRIEF DESCRIPTION OF THE DRAWINGS

FIG. 1 is a simplified side view of a lithographic system having a mold spaced-apart from a substrate;

FIG. 2 is a side view of the substrate shown in FIG. 1, having a patterned layer thereon;

FIG. 3 a flow chart showing a process for replicating an imprinting surface in an imprint lithography process;

FIG. 4 is a flow chart that depicts generating a fluid map.

FIG. 5 is a flow chart that depicts generating a fluid drop pattern from a fluid map.

FIG. 6 shows a single drop pattern generated in a CVT process for an un-patterned imprinting surface;

FIG. 7 shows a multiple drop pattern generated in a dual CVT process for an un-patterned imprinting surface

FIG. 8 shows a single drop pattern for a complex patterned region generated by a CVT process.

### DETAILED DESCRIPTION

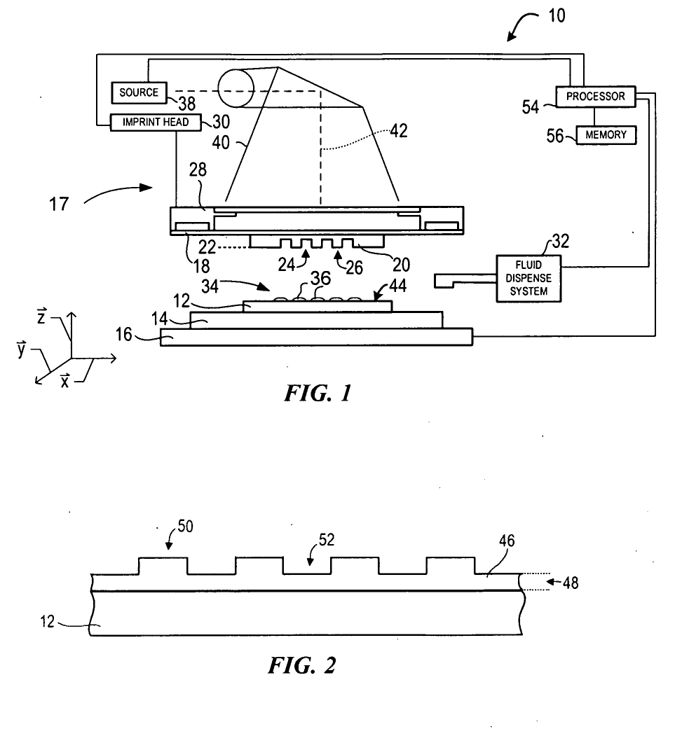

Referring to FIG. 1, a system 10 for forming a relief pattern on a substrate 12 is shown. Substrate 12 may be coupled to a substrate chuck 14. As shown substrate chuck 14 is a vacuum chuck, however, substrate chuck 14 may be any chuck including, but not limited to, vacuum, pin-type, groove-type, or electromagnetic, as described in U.S. Pat. No. 6,873,087, entitled “High-Precision Orientation Alignment and Gap Control Stages for Imprint Lithography Processes,” which is incorporated herein by reference. Substrate 12 and substrate chuck 14 may be supported upon a stage 16. Further, stage 16, substrate 12, and substrate chuck 14 may be positioned on a base (not shown). Stage 16 may provide motion about the x and y axes.

Spaced-apart from substrate 12 is a patterning device 17. Patterning device 17 includes a template 18 having a mesa 20 extending therefrom towards substrate 12 with a patterning surface 22 thereon. Further, mesa 20 may be referred to as a mold 20. Mesa 20 may also be referred to as a nanoimprint mold 20. In a further embodiment, template 18 may be substantially absent of mold 20. Template 18 and/or mold 20 may be formed from such materials including, but not limited to, fused-silica, quartz, silicon, organic polymers, siloxane polymers, borosilicate glass, fluorocarbon polymers, metal, and hardened sapphire. As shown, patterning surface 22 includes features defined by a plurality of spaced-apart recesses 24 and protrusions 26. However, in a further embodiment, patterning surface 22 may be substantially smooth and/or planar. Patterning surface 22 may define an original pattern that forms the basis of a pattern to be formed on substrate 12. Template 18 may be coupled to a template chuck 28, template chuck 28 being any chuck including, but not limited to, vacuum, pin-type, groove-type, or electromagnetic, as described in U.S. Pat. No. 6,873,087, entitled “High-Precision Orientation Alignment and Gap Control Stages for Imprint Lithography Processes”. Further, template chuck 28 may be coupled to an imprint head 30 to facilitate movement of template 18, and therefore, mold 20.

System 10 further includes a fluid dispense system 32. Fluid dispense system 32 may be in fluid communication with substrate 12 so as to deposit polymerizable material 34 thereon. System 10 may include any number of fluid dispensers, and fluid dispense system 32 may include a plurality of dispensing units therein. Polymerizable material 34 may be positioned upon substrate 12 using any known technique, e.g., drop dispense, spin-coating, dip coating, chemical vapor deposition (CVD), physical vapor deposition (PVD), thin film deposition, thick film deposition, and the like technique. Polymerizable material 34 can be disposed upon substrate 12 before the desired volume is defined between mold 20 and substrate 12. However, polymerizable material 34 may fill the volume after the desired volume has been obtained.

Referring to FIGS. 1 and 2, system 10 further includes a source 38 of energy 40 coupled to direct energy 40 along a path 42. Imprint head 30 and stage 16 are configured to arrange mold 20 and substrate 12, respectively, to be in superimposition and disposed in path 42. Either imprint head 30, stage 16, or both vary a distance between mold 20 and substrate 12 to define a desired volume therebetween that is filled by polymerizable material 34. After the desired volume is filled with polymerizable material 34, source 38 produces energy 40, e.g., broadband ultraviolet radiation that causes polymerizable material 34 to solidify and/or cross-link, conforming to the shape of a surface 44 of substrate 12 and patterning surface 22, defining a patterned layer 46 on substrate 12. Patterned layer 46 may include a residual layer 48 and a plurality of features shown as protrusions 50 and recessions 52. System 10 may be regulated by a processor 54 that is in data communication with stage 16, imprint head 30, fluid dispense system 32, and source 38, operating on a computer readable program stored in memory 56.

The above-mentioned may be further employed in imprint lithography processes and systems referred to in U.S. Pat. No. 6,932,934 entitled “Formation of Discontinuous Films During an Imprint Lithography Process;” U.S. Pat. No. 7,077,992, entitled “Step and Repeat Imprint Lithography Processes;” and U.S. Pat. No. 7,179,396, entitled “Positive Tone Bi-Layer Imprint Lithography Method”; and U.S. Pat. No. 7,396,475, entitled “Method of Forming Stepped Structures Employing Imprint Lithography,” all of which are incorporated by reference herein. In a further embodiment, the above-mentioned may be employed in any known technique, e.g., photolithography (various wavelengths including G line, I line, 248 nm, 193 nm, 157 nm, and 13.2-13.4 nm), contact lithography, e-beam lithography, x-ray lithography, ion-beam lithography and atomic beam lithography.

Current imprint lithography systems and methods, as described in U.S. Patent Application Publication No. 2005/0270312, filed as U.S. patent application Ser. No. 11/143,092 entitled “Fluid Dispensing and Drop-On-Demand Dispensing for Nano-Scale Manufacturing” and U.S. Patent Application Publication No. 2005/0106321, filed as U.S. patent application Ser. No. 10/714,088 entitled “Dispense Geometry to Achieve High-Speed Filling and Throughput”, both of which are incorporated by reference herein, use drop-on-demand technology to place drops of polymerizable material on a substrate before imprinting. The fluid dispenser dispenses fluid in discrete volumes and at discrete locations. This method is useful for any imprint system using drop-on-demand application with these constraints.

A fluid drop pattern can be generated for use with an imprinting (e.g., patterning) surface in an imprint lithography process. When polymerizable material is applied to the substrate according to the drop pattern, the polymerizable material substantially completely fills features of the imprinting surface during the imprinting process. After polymerization, the imprinting surface is successfully replicated in the patterned layer (e.g., the size and shape of the protrusions in the patterned layer substantially match the size and shape of the corresponding recesses in the imprinting surface, if present) and the residual layer is of a desired, substantially uniform thickness.

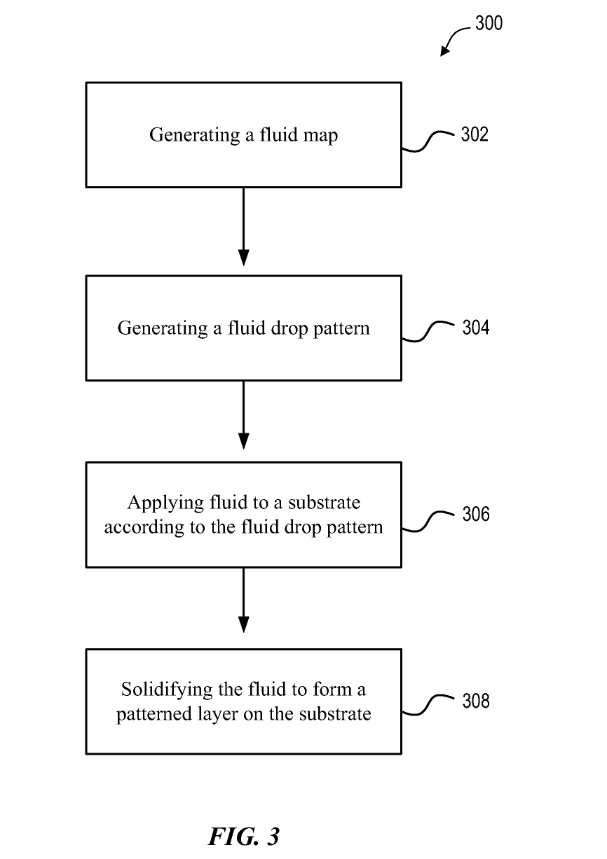

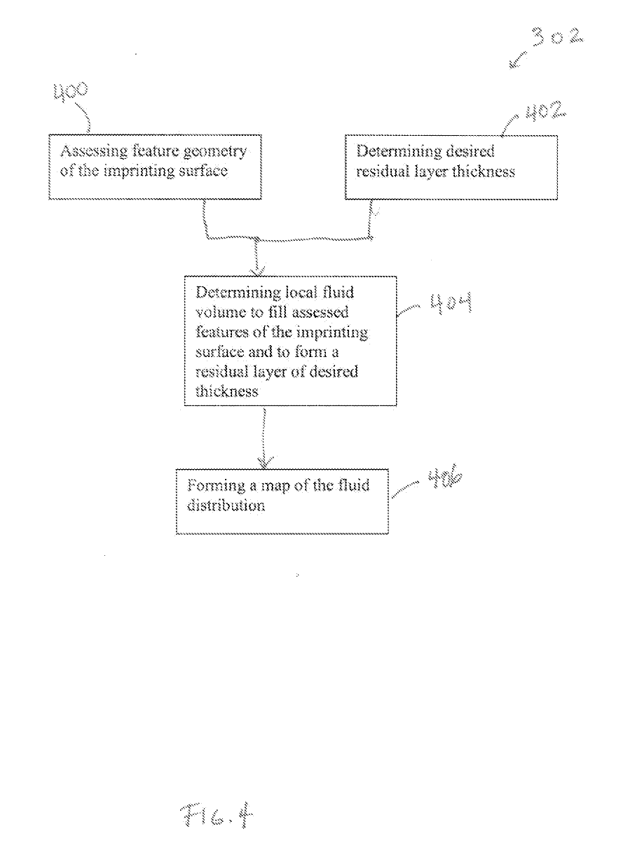

FIG. 3 is a flow chart showing a process for replicating an imprinting surface in an imprint lithography process. Process 300 includes generating a fluid map 302, generating a fluid drop pattern 304, applying fluid to a substrate according to the fluid drop pattern 306, conforming to the shape of a surface of the substrate and the patterning surface, and solidifying the fluid to form a patterned layer on the substrate 308. The fluid can be, for example, a polymerizable material.

FIG. 4 is a flow chart that depicts generating the fluid map 302. Generating the fluid map 302 includes assessing the feature geometry of the imprinting surface 400 and determining the desired residual layer thickness 402. Step 404 includes determining the local fluid volume needed to fill the assessed features of the imprinting surface and to form a residual layer of the desired thickness. Step 406 includes forming a map of the fluid distribution (e.g., a fluid map representing local fluid volume needed) that will allow successful replication of the imprinting surface in an imprint lithography process. In some cases, the map is a two-dimensional array of cells, in which each cell represents a spatial region of the imprinting area and has an associated fluid volume. Properties of the fluid (e.g., shrinkage of polymerizable material), the substrate (e.g., surface energy), and the fluid applicator (e.g., calibration parameters, drop volumes, etc.), may be used in generating the fluid map.

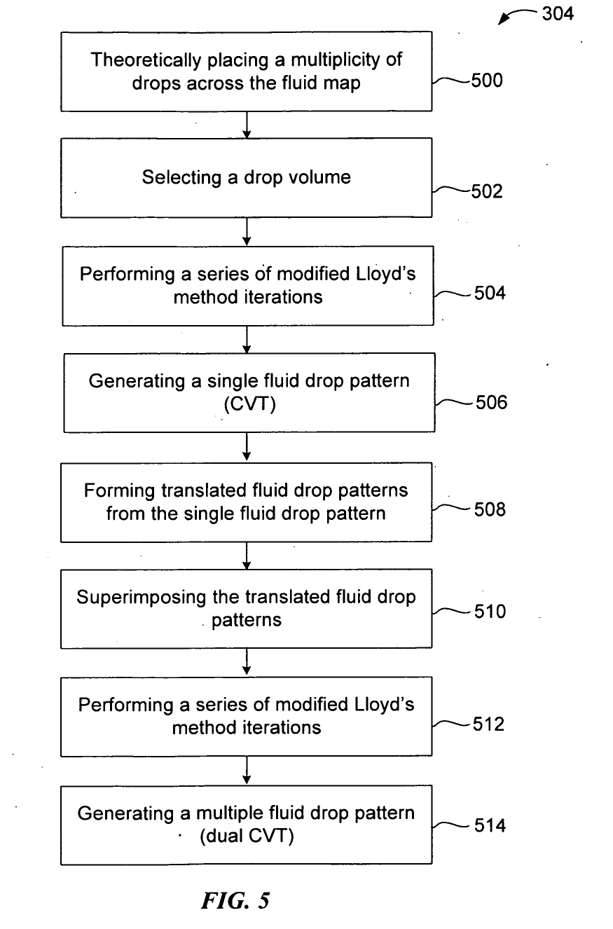

FIG. 5 is a flow chart that depicts generating a fluid drop pattern 304 from a fluid map for a selected imprint area. Generating a fluid drop pattern 304 includes theoretically placing a multiplicity of drops across the fluid map 500. In some cases, no two drop locations map to the same fluid map cell. A fixed drop volume is selected 502. The fixed drop volume may be determined by the drop applicator. The fixed drop volume and number of drops are selected such that the sum of drop volumes of the multiplicity of drops is substantially equal to the sum of the cell volumes in the fluid map. In some cases, generating a fluid drop pattern is expedited by selecting an initial drop pattern that at least roughly corresponds to the fluid distribution in the fluid map.

When the fluid map represents a substantially uniform volume distribution (e.g., the imprinting surface is substantially “unpatterned,” or without intentional protrusions and recesses), the fluid volume associated with each fluid map cell can be substantially the same. When the fluid map represents a non-uniform volume distribution (e.g., the imprinting surface is “patterned,” or with intentional protrusions and recesses), however, fluid volume associated with a fluid map cell can vary based upon the features of the imprinting surface associated with the cell. In this case, the volume of the theoretical drop chosen to fill the fluid map cell can vary based upon the features of the imprinting surface associated with the cell and the size of the cell.

To allow for a substantially uniform drop volume in the fluid drop pattern, as required by some fluid applicators, while achieving the desired non-uniform volume distribution in the imprinting area, a series of modified Lloyd's method iterations may be performed 504. Lloyd's method is described in “Random Marks on Paper, Non-Photorealistic Rendering with Small Primitives,” Adrian Secord, Master's Thesis, The University of British Columbia, October 2002, which is incorporated by reference herein. This method includes computing the Voronoi diagram of the generating points in the imprinting area, computing the centroid of each Voronoi region in the diagram, and moving each generating point to its centroid.

The modified Lloyd's method iterations used herein involve computing the Voronoi tessellation of the drop pattern (that is, breaking it into regions that are closer to that drop than any other). Then, instead of moving the drop to the center of mass of its Voronoi region as with Lloyd's method, the drop is moved to a location that coincides with a weighted mean of all of the Voronoi region centers of mass. Each center of mass is weighted based on its volume deficit and the distance between the centers of mass of the Voronoi regions of the two drops. This modification to Lloyd's method allows the drop locations to converge to a result in which drop densities approximate the fluid density in the underlying fluid map. Without this modification to Lloyd's method, drops converge to a solution that is well-spaced, but that does not necessarily fit the underlying fluid density changes.

The modified Lloyd's method iterations transform the drop distribution based on fluid map cells to a distribution based on an approximate centroidal Voronoi tessellation in which the volume of the modified fluid map cells (now Voronoi regions) associated with a drop location is close to a fixed volume. Iterations are continued until a user intervenes, a convergence criterion is met, or a pre-determined length of time has elapsed. A fluid drop pattern is generated 506 following convergence of the modified Lloyd's method.

The single drop pattern generated in the centroidal Voronoi tessellation (CVT) process in steps 504 and 506 can be used to form multiple drop patterns (i.e., a drop pattern in which each Voronoi region includes more than one drop). The single drop pattern can be translated a distance (e.g., one fluid map cell width) in one or more different directions to form one or more additional, translated or shifted drop patterns 508. The translated drop patterns can be superimposed to form a multiple drop pattern with multiple drops (i.e., higher drop density) in each Voronoi region 510. The higher drop density may allow for more complete filling of features, if present in an imprinting surface. The higher drop density may also allow for quicker, more complete removal of gases from interstitial regions between drops during an imprinting process.

The superimposed drop pattern formed in step 510 is then run through a second round of modified Lloyd's method iterations 512 in a dual CVT process, causing the shifted drop locations to spread to a uniform distance that approximates the initial fluid map. To reduce non-uniformity of the shifted drop patterns, iterations of the shifted patterns can be combined with (e.g., alternated with) individual iterations on each drop pattern, and appropriate weighting factors can be applied to each type of iteration. A multiple fluid drop pattern is generated 514 following the second iteration and convergence of the modified Lloyd's method.

When a multiple drop pattern is not advantageous, a single drop pattern can be used, and the formation of shifted drop patterns is not necessary. Whether one drop pattern or multiple drop patterns are used, after iterations are complete, fluid is applied to a substrate 306 according to the fluid drop pattern such that each drop is matched to an available (e.g., the nearest available) fluid applicator drop location. The fluid, deposited according to the fluid drop pattern, is then contacted with an imprinting surface and polymerized 308 to form a patterned layer on a substrate.

If only a single drop pattern is required (i.e., a drop pattern in which each Voronoi region includes a single drop), then the fluid drop pattern is generated in step 506. FIG. 6 shows a single drop pattern 600 generated in a CVT process for an un-patterned imprinting surface. Single drop pattern 600 shows hexagonal close packing of drop locations 602 in Voronoi regions. The drop locations 602 are distributed across the imprinting area such that the desired volume distribution is achieved with a substantially constant drop volume in each Voronoi region.

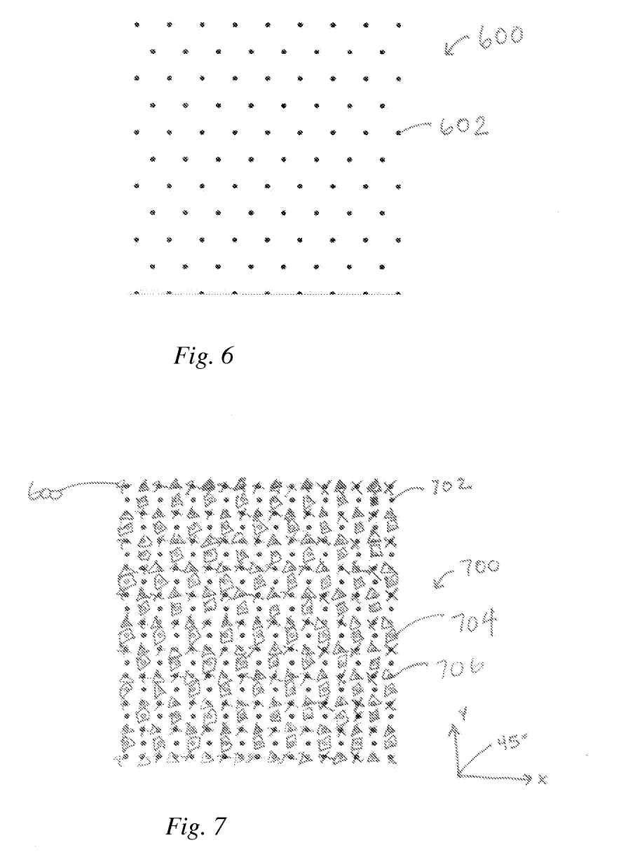

Referring to FIG. 7, multiple drop pattern 700 can be formed by shifting single drop pattern 600 (including drop locations 602, shown by “x”) to form additional drop patterns, and superimposing a combination of the single drop patterns to form a pattern with a higher density of drop locations. In an example, a first additional pattern can be generated by shifting the single drop pattern 600 in a positive direction along both x and y axes (e.g., +45°) to form drop locations 702 (shown by circles). A second additional pattern can be generated by shifting the initial pattern in a negative direction along both x and y axes (e.g., −135°) to form drop locations 704 (shown by squares). A third additional pattern can be generated by shifting the initial pattern in a positive or negative direction along the x axis to form drop locations 706 (shown by triangles). Drop patterns formed from drop locations 702, 704, and 706 can be superimposed to form drop pattern 700. In some cases, superimposition of the drop patterns can be achieved such that the origin of a drop location can be traced to its drop pattern of origin (e.g., initial pattern or shifted pattern).

A second consecutive iterative process (dual CVT) is applied to the superimposed drop pattern to form multiple drop pattern 700. Following the dual CVT process, the total drop volume in the imprinting area for the multiple drop pattern is substantially the same as the total drop volume in the imprinting area for the single drop pattern. For example, the volume of drops 602, 702, 704, and 706 in multiple drop pattern 700 can each be about ¼ of the drop volume of drops 602 in single drop pattern 600. The hexagonal packing of FIG. 6 is preserved by the superimposed pattern in FIG. 7.

The efficacy of a drop pattern can be quantified by the distribution of fluid volumes in Voronoi regions. Convergence criteria can take the form of maximum Voronoi region volume or standard deviation of Voronoi region volumes. This can also be used to quantify error induced by producing shifted drop patterns and by matching drop locations in a drop patterns to fluid dispenser or applicator locations.

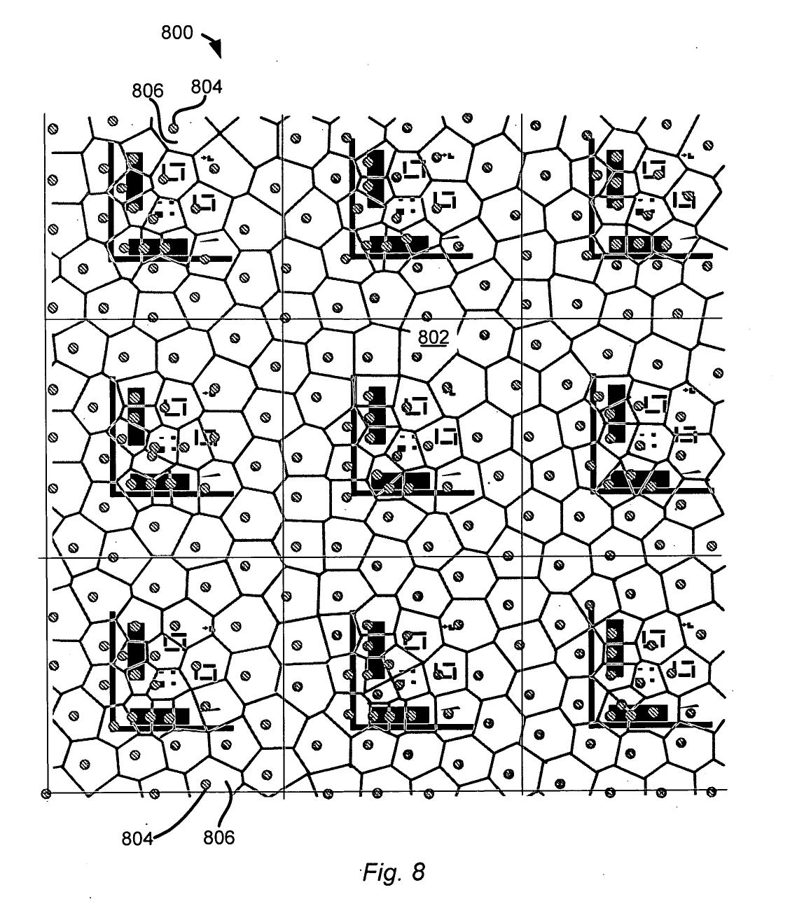

FIG. 8 shows a single drop pattern 800 generated by a CVT process from fluid map 802 for a complex patterned region. Fluid map 802 includes nine substantially similar cells, with shaded regions indicating features in the imprinting surface. Regions without shading indicate portions of the template where features are substantially absent (i.e., regions that receive fluid to form a residual layer). Drop locations 804 are shown in Voronoi regions 806. As indicated in FIG. 8, drop density is higher proximate shaded regions of the fluid map (i.e., proximate regions with features in the imprinting surface).

The embodiments of the present invention described above are exemplary. Many changes and modifications may be made to the disclosure recited above, while remaining within the scope of the invention. Therefore, the scope of the invention should not be limited by the above description, but instead should be determined with reference to the appended claims along with their full scope of equivalents.

1. A method of generating a fluid drop pattern for an imprint lithography process, the method comprising:
selecting an imprinting surface; and
generating a fluid drop pattern comprising drop locations for placement of a multiplicity of drops of substantially equal volume on a substrate, such that the pattern allows successful replication of the imprinting surface, wherein the drop locations are derived from modified Lloyd's method iterations.

2. The method of claim 1, wherein the method is automated.

3. The method of claim 1, wherein the imprinting surface comprises recesses and protrusions.

4. The method of claim 3, wherein successful replication of the imprinting surface comprises substantially completely filling the recesses of the imprinting surface with fluid during the imprint lithography process.

5. The method of claim 1, wherein successful replication of the imprinting surface comprises forming a residual layer of a substantially uniform thickness on the substrate.

6. The method of claim 1, further comprising translating the fluid drop pattern to form a shifted fluid drop pattern.

7. The method of claim 6, further comprising superimposing the shifted fluid drop patterns to form a superimposed drop pattern.

8. The method of claim 7, further comprising applying modified Lloyd's method iterations to the superimposed drop pattern to form a multiple drop pattern.

9. The method of claim 1, wherein the drop locations are substantially equally spaced.

10. A method of forming a patterned layer on a substrate in imprint lithography, the method comprising:
selecting an imprinting surface;
generating a fluid map, wherein the fluid map represents a distribution of fluid volume effective to allow successful replication of the imprinting surface;
using a modified Lloyd's method to generate a fluid drop pattern from the fluid map, wherein the fluid drop pattern comprises drop locations for drops of substantially equal volume;
applying fluid to the substrate according the fluid drop pattern; and
solidifying the fluid on the substrate to form a patterned layer on the substrate, wherein the patterned layer is a successful replication of the imprinting surface.

11. The method of claim 10, wherein the modified Lloyd's method generates an approximate centroidal Voronoi tessellation.

12. The method of claim 11, wherein the approximate centroidal Voronoi tessellation comprises a multiplicity of Voronoi regions.

13. The method of claim 12, wherein each Voronoi region comprises one of the fluid drop locations.

14. The method of claim 10, further comprising translating the fluid drop pattern to form shifted fluid drop patterns.

15. The method of claim 14, further comprising superimposing the shifted fluid drop patterns to form a superimposed fluid drop pattern.

16. The method of claim 15, further comprising using a modified Lloyd's method to form a multiple fluid drop pattern from the superimposed fluid drop pattern.

17. A patterned imprint lithography formed by the method of claim 13.
